(19) United States
(12) Patent Application Publication
(10) Pub. No.: US 2026/0029161 A1
(43) Pub. Date: Jan. 29, 2026

(54) MOBILE AIR HEATER

(71) Applicant: Dometic Sweden AB, Solna (SE)

(72) Inventors: Sergej Krist, Neunkirchen (DE); Tim Jochim, Wilnsdorf (DE); Henrik Hildebrand, Rheine (DE); Michael Steiger, Wenden (DE); Tobias Suchanek, Siegen (DE)

(21) Appl. No.: 18/993,224

(22) PCT Filed: Jul. 10, 2023
(86) PCT No.: PCT/EP2023/069009

§ 371 Date: Jan. 10, 2025

(30) Foreign Application Priority Data
Jul. 11, 2022 (DE) 10 2022 207 062.3

(51) Int. Cl. F24H 3/04; B60H 1/00; F24H 9/00

(52) U.S. Cl. CPC F24H 3/0417; B60H 1/00264; F24H 9/0068; F24H 9/0073

(57) ABSTRACT

A mobile heater adapted to heat air from the environment and to supply the heated air into a cabin like a recreational vehicle or a tent, the heater comprises a housing, a supply air inlet arranged at a side of the housing, a supply air outlet arranged at another side of the housing, a supply air channel inside the housing extending the between the supply air inlet and the supply outlet, means for generating a supply air flow inside the supply air channel from the supply air inlet to the supply air outlet, and flexible supply air hose that can be removably coupled to the supply air outlet and by means of which the heated air can be led inside the cabin, the heater further comprises a burner chamber inside the housing, wherein the supply air channel passes through the burner chamber, a burner arranged inside the burner chamber, a heat exchanger arranged inside the burner chamber and being designed as a tube section that forms at least a section of the supply air channel, a control unit and a user interface , wherein the burner extends below and along a vertical projection of the heat exchanger, and the heat exchanger has a plurality of first

lamellas and second lamellas, wherein the first lamellas extend from the outer surface of the tube section inside the burner chamber and parallel to a vertical plane, and the second lamellas extend from the inner surface of the tube section inside the supply air channel and along the direction of the supply air flow.

### PRIORITY/INCORPORATION BY REFERENCE

Any and all applications for which a foreign or domestic priority claim is identified in the Application Data Sheet as filed with the present application are hereby incorporated by reference herein and made a part of the present disclosure

### BACKGROUND

The present embodiments relate to a mobile heater for heating air and supplying the heated air to a cabin like a recreational vehicle or a tent.

The present teaching concerns the field of outdoor activities and in particular outdoor heaters used, for example, for tents. Generally, such heaters are operated by gas combustion and are therefore placed outside the tent in the environment, to prevent that the exhaust gases are inhaled by the user. The warm air generated by the heater is guided by a hose inside the tent. A problem with such gas heaters is the poor efficiency at which the combustion heat is finally used for heating the inside of the tent. As a consequence, heat escapes unnecessarily into the environment and gas consumption is correspondingly high, which is why more gas must be carried on an outdoor trip.

In order to solve this problem, the present embodiments provide mobile heater adapted to heat air from the environment and to supply the heated air into a cabin like a recreational vehicle or a tent. The heater comprises a housing, a supply air inlet arranged at a side of the housing, a supply air outlet arranged at another side of the housing, a supply air channel inside the housing extending the between the supply air inlet and the supply air outlet, means for generating a supply air flow inside the supply air channel from the supply air inlet to the supply air outlet, and a flexible supply air hose that can be removably coupled to the supply air outlet and by means of which the heated air can be led inside the cabin. The heater further comprises a burner chamber inside the housing, wherein the supply air channel passes through the burner chamber, a burner arranged inside the burner chamber, a heat exchanger arranged inside the burner chamber and being designed as a tube section that forms at least a section of the supply air channel, a control unit and a user interface.

### SUMMARY

According to the present embodiments, the burner extends below and along a vertical projection of the heat exchanger, and the heat exchanger has a plurality of first lamellas and second lamellas, wherein the first lamellas extend from the outer surface of the tube section within the burner chamber and parallel to a vertical plane, and the second lamellas extend from the inner surface of the tube section inside the supply air channel and along the direction of the supply air flow.

The mutual arrangement of the burner and the heat exchanger and the provision of the lamellas according to the present disclosure provide for an ideal flow of the hot air rising from the burner around the heat exchanger in order to efficiently transfer the heat to the supply air flow. Extending along a vertical projection of the heat exchanger means that if one considers a vertical projection of the heat exchanger on a plane below the heat exchanger, this projection describes a certain path in this plane, regardless of whether the heat exchanger additionally extends upwards, downwards or whether it extends only at a constant level. The burner follows said path and is thus positioned right below the heat exchanger.

According to some embodiments, each of the first lamellas extends perpendicular to the longitudinal direction of a vertical projection of the tube section onto a horizontal plane. That is, the tube section or the heat exchanger in its vertical projection can be curved or straight and each first lamella is oriented perpendicular to the direction the vertical projection specifically has at that point where the first lamella is located. This further increases the efficiency of the heater.

According to some embodiments, the supply air inlet and the supply air outlet are arranged at opposites sides of the housing and the supply air channel extends horizontally. That is, the tube section and thus the heat exchanger which forms part of the supply channel also extends horizontally. Thereby, the efficiency of the heater is even further increased and the manufacture of the heater is facilitated.

According to some embodiments, in the cross section of the tube section, the second lamellas extend vertically from the top downwards and from the bottom upwards, leaving clear a horizontal passage in the tube section, or the second lamellas extend horizontally from both sides, leaving clear a vertical passage essentially in the center of the tube section. This provides for an efficient heat transfer from the heat exchanger to the supply air flow.

According to some embodiments, the heater comprises air intake openings at a bottom side of the housing for air feed into the burner chamber, and air outlet openings on at least one side of the housing and at the level of the heat exchanger or higher. This ensures efficient air flow in the burner chamber.

According to some embodiments, the means for generating the supply air flow comprises a fan arranged near the supply air inlet. As such, the fan does not get hot during use.

According to some embodiments, the heater further includes a rechargeable battery. Preferably, the heater can also be operated with a power cable connected to a socket or other power source, for example in a mobile home.

According to some embodiments, the user interface includes a display. This provides for a comfortable operation and selection of certain modes of the heater.

According to some embodiments, the heater further includes an external sensor configured to be in electronic communication with the control unit for monitoring and/or controlling the temperature inside the cabin. The sensor can be coupled to the control unit by a wiring or wireless, for example, via Bluetooth. The sensor is included in a remote control so that the temperature can be adjusted from inside the cabin.

According to some embodiments, the heater includes an additional flexible supply air hose which can be removably coupled to the supply air inlet. Thereby, the user can decide to a certain extent from where the air to be heated is sucked into the heater.

The heater may be configured to be operable in an circulating air mode in which the supply air is taken from the cabin via the additional supply air hose. Thereby, the heating efficiency can be further increased. When using the heater in such a mode of operation, of course, it must be ensured by other means that the cabin is supplied with sufficient fresh air. For this purpose, the supply air hose by which the air to be heated is taken from the cabin can be provided with means like openings or valves that allow a certain amount of fresh air to enter the supply air channel.

According to another embodiment, the heater is configured to be operable in a ventilation mode in which air from the environment is supplied to the cabin while the burner is not activated. Thereby, the humidity inside the cabin can be lowered.

According to some embodiments, the control unit is operable wirelessly, with a corresponding app on a mobile phone communicating with the control unit via Bluetooth. This increases the comfort in operating the heater.

According to some embodiments, the heater may further comprise an oxygen depletion sensor (ODS) configured to measure the oxygen content in the supply air, and that the control unit is configured to turn off the heater when the measured oxygen content is below a predetermined threshold level. Turning off the heater generally includes a closure of the gas supply to the burner. This increases the safety for the user, if for some reason the combustion air enters the supply air channel.

According to some embodiments, the heater further includes at least one thermal sensor being in electronic communication with the control unit and being arranged in the burner chamber above the heat exchanger and/or inside the supply air channel in the vicinity of the supply air outlet, and the control unit is configured to turn off the heater when the temperature is above a predetermined threshold value. This prevents the heater from overheating and thus increases the safety for the user.

According to some embodiments, the heater further includes a tip-over switch configured to turn off the heater in case the heater falls over. In this way fire accidents can be avoided.

According to some embodiments, the heater further includes a microswitch being installed in a way that the correct coupling of the supply air hose to the supply air outlet can be verified, and which is configured to disable the operation of the burner as long as the microswitch is not activated. Also here, the expression of disabling the operation of the burner includes a closure of the gas supply to the burner. This prevents a significant thermal loss in the event that the supply air hose is not tightly connected to the heater.

The use of the heater is not particularly limited. In addition to being used as a tent heater, the heater is also suitable for small houses, garden and wooden houses, shelters, hunters' huts, panel vans, etc.

Terms describing an orientation in space like “vertical” or “horizontal” are to be understood with respect to the heater being placed on the ground as intended.

### BRIEF DESCRIPTION OF THE DRAWINGS

These and other features of the present embodiments will become more apparent from the following detailed description of a non-limiting exemplary embodiment of the present teaching, with reference to the accompanying drawings, wherein:

FIG. 1 is a perspective view on the air heater according to an embodiment of the present disclosure;

FIG. 2 is another perspective view on the embodiment shown in FIG. 1;

FIG. 3 is a perspective view at the inside of the embodiment shown in FIG. 1; and

FIG. 4 is another perspective view at the inside of the embodiment shown in FIG. 1.

### DETAILED DESCRIPTION

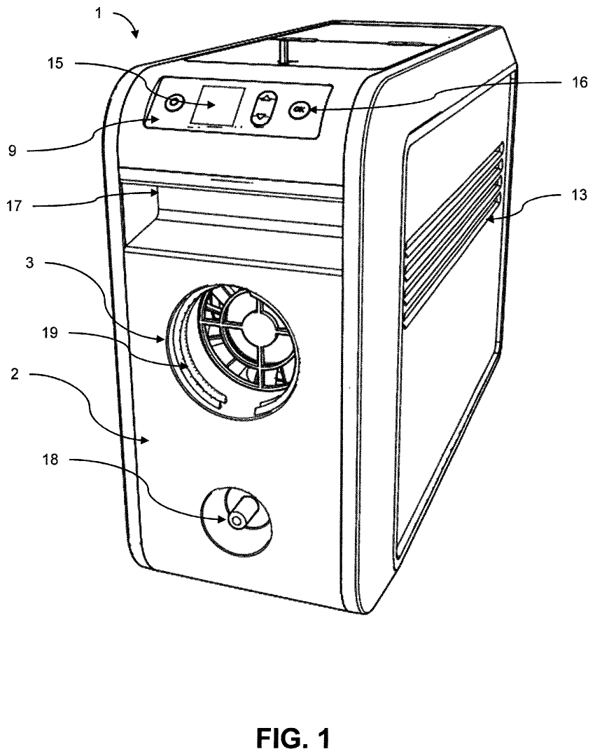

In the following, an exemplary configuration for an air heater according to the present embodiments will be described with respect to FIGS. 1 to 4.

The shown mobile air heater 1 is generally box-shaped and has a housing 2 of a rigid and whether resistant material so that it can be used outdoors and can be exposed to wind and weather. The heater 1 can be carried easily by the user using the handles 17 provided at the opposite narrow sides of the heater 1. Each handle 17 is formed as a grip shell so that the respective sides remain flat and there are no protrusions.

For convenient operation of the heater 1, the user interface 9 is provided on an upper edge of the heater 1. The user interface 9 includes a display 15 and buttons 16 for a number of setting options, such as setting the desired temperature of the supply air, the airflow rate, certain time windows for programmed temperature control, and certain operating modes, which will be described in more detail below.

Further, and also at opposite sides of the heater 1, there are provided the supply air inlet 3 and the supply air outlet 4 to each of which a flexible supply air hose can be coupled via the inner thread 19 provided in each of the supply air inlet 3 and the supplier outlet 4. Each of the supply air inlet 3 and the supplied air outlet 4 is formed integrally with the respectively surrounding outer case 2 material which is made up of a heat resistant plastic. In this embodiment, inlet 3 and outlet 4 are provided at the same sides as the handles 17 and right below them. However, there is no mandatory requirement for this specific arrangement. The supply air inlet 3 and the supply air outlet 4 are each circular in cross-section and have a rather broad diameter which leads to a reduction of noise generated by the air flow within the supply air channel 5 and the supply air hoses.

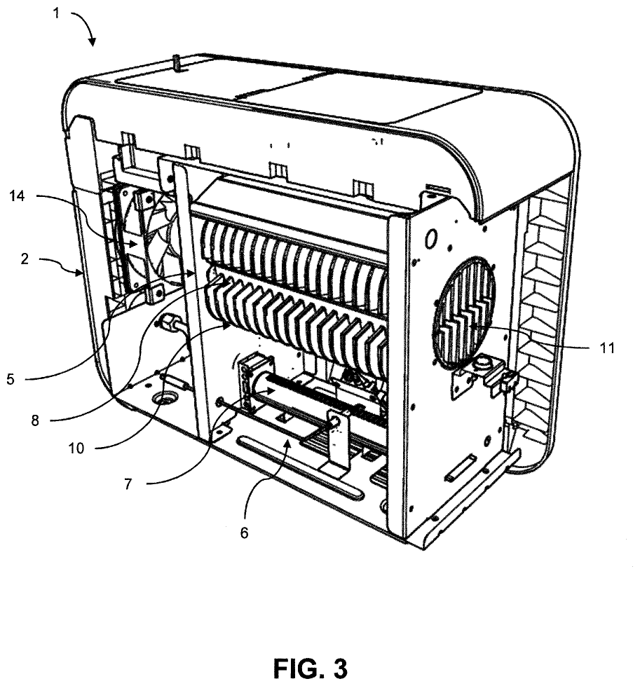

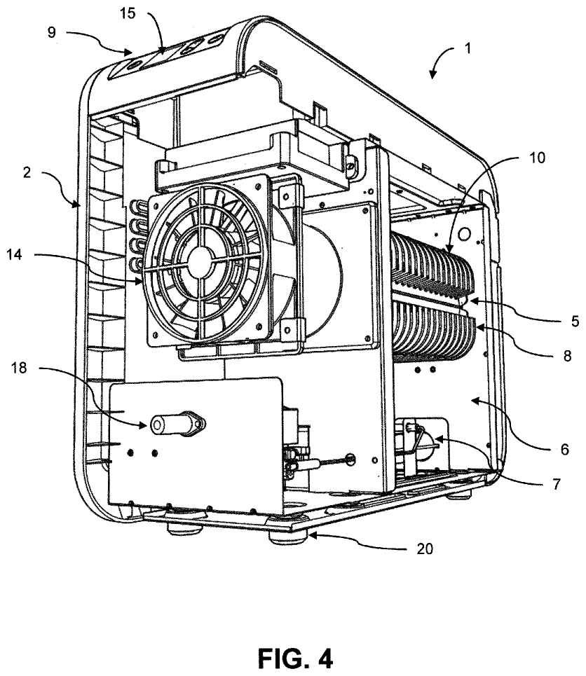

The supply air channel 5 is here defined as reaching from the supply air inlet 3 to the supplier outlet 4. As it is best seen in FIGS. 3 and 4, the fan 14 is arranged near the beginning of the supply air channel 5 right after the supply air inlet 3 when considering the intended airflow direction. At the opposite side and rather at the end of the supply air channel 5, the heat exchanger 8 is provided. The heat exchanger 8 is surrounded by several heat shields defining the burner chamber 6. The fan 14 is arranged with a significant distance to the burner chamber 6 in order to protect the fan from the heat generated inside the burner chamber 6. For this purpose, an intermediate part of the supply air channel 5 bridges the distance between the fan and the burner chamber 6.

The entire supply air channel 5 is formed as a straight and tube-like extension of the heat exchanger 8 is basically formed as a tube section forming part of supplier channel 5. The purpose of the heat exchanger 8 is to transfer the heat inside the burner chamber 6 to the supply air flow inside the supply air channel 5. Inside the burner chamber 6 and right below the heat exchanger 8, the gas burner 7 is provided which is supplied with gas via the gas introduction port 18. The control of the gas supply and the ignition and control of the flame are achieved by techniques well known in the art which are therefore not specifically described herein. When the heater 1 is operated and the gas is burned by the burner 6, the hot air rises up from the burner 6 and flows around the heat exchanger 8 in order to transfer the thermal energy to the aid exchanger 8. In order to provide an ideal airflow for an efficient heat transfer, air vents are provided in the case 2 of the heater 1. Fresh air from the environment enters the burner chamber 6 from below the heater 1 via the air inlet openings 12 for combustion. In order to prevents blockage of the air inlet openings 12 by the ground, the heater 1 stands on four feet 20. Finally, the consumed air, after having dissipated a large part of its heat, exits from the air outlet openings 13 provided at opposite sides of the case 2 and which are arranged alongside the heat exchanger 8 at least at the same level of the heat exchanger 8 but preferably above the heat exchanger 8.

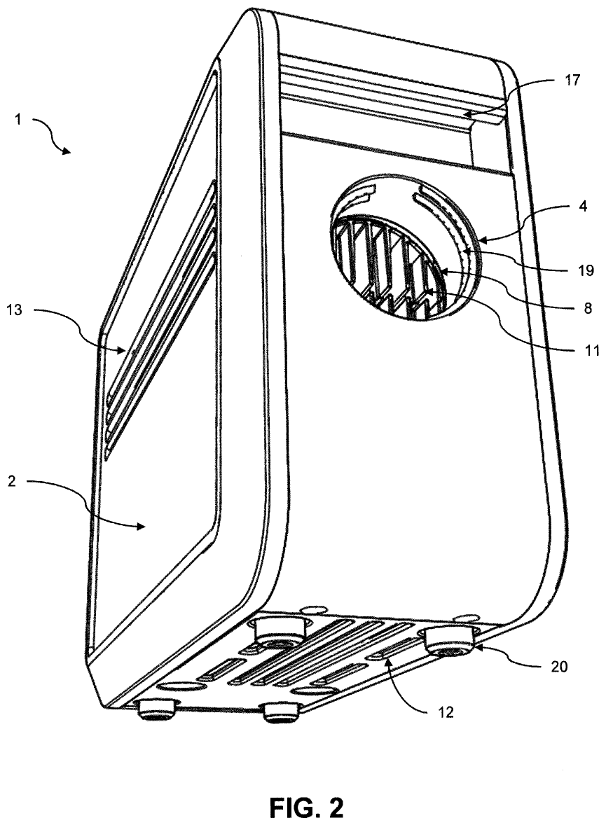

Furthermore, for an effective transfer of the thermal energy from the consumed air, the heat exchanger 8 has a plurality of first lamellas 10 provided at the outside of the tube section and a plurality of second lamellas 11 provided at the inside of the tube section which is best seen in FIGS. 3 and 2, respectively. Each of the first lamellas 10 extends almost around the entire circumference of the tube section of the heat exchanger 8. However, for reasons of the manufacturing process of the heat exchanger, a small part is left out so that the parts of the tube section can be welded together. The first lamellas 10 are generally oriented along the airflow inside the burner chamber 6. In this embodiment, the first lamellas 10 are arranged vertically and perpendicular to the direction of the tube section. Thus, the first lamellas 10 can be arranged closely packed to each other, which increases the efficacy. The same principle is applied in the arrangement of the second lamellas 11 inside the heat exchanger 8. Also here, the second lamellas 11 are flat and arranged parallel to each other and along the airflow direction within the airflow channel 5. In this case, the second lamellas 11 are vertically arranged. However, in view of the intended flow direction, the second lamellas 11 could either be horizontally arranged or be inclined about any angle as long as each of the second lamellas 11 is arranged parallel to the longitudinal axis of the tube section of the heat exchanger 8. Further, for an effective air flow inside the heat exchanger and an ideal mixing of the air, the second lamellas 11 reaching in principle from one side of inner surface of the tube section to the other side are interrupted at about the middle of the tube section, thereby forming or leaving clear a horizontal channel.

In the following, certain modes of use of the heater 1 are described. For a heating cabin like a tent, the heater 1 is placed outside in the heat is rooted by the flexible supply air hoses to the inside of the tent furthermore, another flexible supply air hose can be coupled to the supply air inlet 3 and the other end of the hose can generally be placed from where the supply air is intended to be take. This can also be from inside the cabin itself which is described herein as the circulating air mode. In the circulating air mode, air from inside the tent is drawn into the heater 1 and supplied back into the tent. This provides for an efficient heating since the air drawn in from the supply air inlet 3 will mostly be already warmer than the ambient air. Of course, when operating the heater 1 in this mode, sufficient venting of the cabin should be ensured, since the heater 1 does not provide for fresh air in this mode.

The heater 1 can furthermore be operated in a ventilation mode in which fresh ambient air is drawn in by the heater 1 and supplied to the inside of the cabin without heating the supply air, i.e. with the burner being disabled. This mode is predominantly advantageous in warmer areas and very effective to get the humidity out of the tent.

All operating modes and functions have corresponding timer functions. Further, all functions and parameters of the heater 1 can be controlled and adjusted by the user via an app on the mobile phone of the user.

The heater 1 has different selectable heating levels which is realized by adjusting the amount of gas fed to the burner 6. Also the flow rate can be adjusted by driving the fan 14 at different rotational speeds. Since the supply air is heated stronger the lower the flow rate is, the temperature is electronically regulated by the use of at least one temperature sensor (not shown) that is located near the end of the supply air channel 5. Thereby, regardless of the air flow rate, a constant temperature of the supply air can be achieved. Alternatively, the temperature can be controlled by temperature sensor is placed inside the cabin and is either wirelessly connected to the control unit of the heater 1 or with a wire. In this way, a simple control can be performed according to which the heating is turned on in case the temperature inside the cabin falls below a predetermined threshold value. Once the temperature inside the cabin exceeds the threshold value, the heating is interrupted again. Useful sensors are negative temperature coefficient (NTC) sensors by wiring or Bluetooth, for example.

A temperature sensor is additionally used to prevent overheating of the heater 1 and is positioned inside the burner chamber 6 above the heat exchanger 8. Alternatively, the temperature sensor can be placed inside the supply air channel 5. Hence the temperature sensor can be used for both the prevention of overheating and for adjusting the temperature inside the cabin.

Furthermore, the heater 1 is provided with several safety features. For instance, the amount of oxygen in the supply air is constantly monitored by an oxygen depletion sensor (ODS). The respective sensor can be positioned inside the cabin and be in wireless or wired electronic communication with the control unit of the heater 1, but preferably, the ODS is located near the supply air outlet 4. As such, an introduction of exhaust air from the burner chamber 6 into the supply air channel due to a damage of the heater 1 can be detected immediately and the heater 1 or at least the gas supply to the burner 6 is switched off by the control unit.

The heater 1 further includes a tip-over switch (not shown) that switches off the heater 1 or at least the gas supply to the burner 6 in case the heater 1 falls over and lies on its side.

In the event of any incident in which one of the safety features becomes active, an alarm is triggered, for example, in the form of an acoustic signal emitted by the heater 1 itself or by an external device such as via the app on the user's smartphone.

The experts in the field of the present teaching will readily appreciate in view of the present disclosure that features which are described in context with each other can also be realized separately as long as the respective context does not indicate otherwise.

### REFERENCE NUMERALS

1 Heater
2 housing
3 supply air inlet
4 supply air outlet
5 supply air channel
6 burner chamber
7 burner
8 heat exchanger
9 user interface
10 first lamellas
11 second lamellas
12 air intake openings
13 air outlet openings
14 fan
15 display
16 button
17 handle
18 gas introduction port
19 thread
20 foot

1. A mobile heater adapted to heat air from the environment and to supply the heated air into a cabin like a recreational vehicle or a tent, the heater comprises
a housing,
a supply air inlet arranged at a side of the housing,
a supply air outlet arranged at another side of the housing,
a supply air channel inside the housing extending the between the supply air inlet and the supply air outlet,
a fan inside the supply air channel from the supply air inlet to the supply air outlet, and
a flexible supply air hose that can be removably coupled to the supply air outlet and by which the heated air can be led inside the cabin,
the heater further comprises a burner chamber inside the housing, wherein the supply air channel passes through the burner chamber,
a burner arranged inside the burner chamber,
a heat exchanger arranged inside the burner chamber and being designed as a tube section that forms at least a section of the supply air channel,
a control unit and
a user interface,
wherein the burner extends below and along a vertical projection of the heat exchanger, and that the heat exchanger has a plurality of first lamellas and second lamellas,
wherein the first lamellas extend from the outer surface of the tube section within the burner chamber and parallel to a vertical plane, and
the second lamellas extend from the inner surface of the tube section inside the supply air channel and along the direction of the supply air flow.

2. The heater of claim 1, wherein each of the first lamellas extends perpendicular to the longitudinal direction of a vertical projection of the tube section onto a horizontal plane.

3. The heater of claim 2, wherein the supply air inlet and the supply air outlet are arranged at opposites sides of the housing and the supply air channel extends horizontally.

4. The heater of claim 3, wherein, in the cross section of the tube section, the second lamellas extend vertically from the top downwards and from the bottom upwards, leaving clear a horizontal passage in the center of the tube section, or the second lamellas extend horizontally from both sides, leaving clear a vertical passage in the tube section.

5. The heater of claim 4, wherein the heater comprises air intake openings at a bottom side of the housing for air feed into the burner chamber, and air outlet openings on at least one side of the housing and at the level of the heat exchanger or higher.

6. The heater of claim 1, wherein the means for generating the supply air flow comprises a fan arranged near the supply air inlet.

7. The heater of claim 1, wherein the heater further includes a rechargeable battery.

8. The heater of claim 1, wherein the user interface includes a display.

9. The heater of claim 1, wherein the heater further includes an external sensor configured to be in electronic communication with the control unit for monitoring and/or controlling the temperature inside the cabin.

10. The heater of claim 1, wherein the heater includes an additional flexible supply air hose which can be removably coupled to the supply air inlet.

11. The heater of claim 10, wherein the heater is configured to be operable in an circulating air mode in which the supply air is taken from the cabin via the additional supply air hose.

12. The heater of claim 1, wherein the heater is configured to be operable in a ventilation mode in which air from the environment is supplied to the cabin while the burner is not activated.

13. The heater of claim 1, wherein the control unit is operable wirelessly, in particular with a corresponding app on a mobile phone communicating with the control unit via Bluetooth.

14. The heater of claim 1, wherein the heater further comprises an oxygen depletion sensor (ODS) configured to measure the oxygen content in the supply air, and that the control unit is configured to turn off the heater when the measured oxygen content is below a predetermined threshold level.

15. The heater of claim 1, wherein the heater further includes at least one thermal sensor being in electronic communication with the control unit and being arranged in the burner chamber above the heat exchanger and/or inside the supply air channel in the vicinity of the supply air outlet, and that the control unit is configured to turn off the heater when the temperature is above a predetermined threshold value.

16. The heater of claim 1, wherein the heater further includes a tip-over switch configured to turn off the heater in case the heater falls over.

17. The heater of claim 1, wherein the heater further includes a microswitch being installed such that the correct coupling of the supply air hose to the supply air outlet can be verified, and which is configured to disable the operation of the burner as long as the microswitch is not activated.
